(19) United States
(12) Patent Application Publication
(10) Pub. No.: US 2006/0044326 A1
(43) Pub. Date: Mar. 2, 2006

(54) System performance information display method, program, and storage medium

(75) Inventors: Yutaka Hiyoshi, (US); Keiko Hiyoshi, Yokohama (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/246,299

(22) Filed: Oct. 11, 2005

Related U.S. Application Data
(63) Continuation of application No. PCT/JP03/04579, filed on Apr. 10, 2003.

(51) Int. Cl. G09G 5/00

(52) U.S. Cl. 345/619

(57) ABSTRACT

A performance information display method for displaying system performance information on a display apparatus comprises: periodically storing the system performance information in a storage device; reading the performance information out of the storage device; displaying the readout performance information based on a time axis; changing, in accordance with a time period to be displayed as the time axis on the display apparatus, a time unit for determining values to be displayed based on the time axis; and displaying the values as average values or peak values taken at intervals of the unit time. The method thus serves to reduce the time and trouble required to display the performance information, and makes it possible to grasp the operating performance of the system accurately.

### CROSS-REFERENCE TO RELATED APPLICATION

This application is a continuation of PCT/JP03/04579, filed on Apr. 3, 2003, the contents being incorporated herein by reference.

### TECHNICAL FIELD

The present invention relates to a system performance information display method, a program, and a storage medium. More particularly, the invention relates to a method for graphically displaying, on a display apparatus, performance information such as the amount of data transfer per unit time, the number of R/W commands per unit time, read response times, or other information concerning the performance of a switch or a redundant array of independent disks (RAID) system, and also relates to a program and a storage medium for use with such a method.

### BACKGROUND ART

The prior art related to the present invention will be described below.

A performance information display function provided in a storage area network (SAN) management application samples performance information at predetermined information sampling intervals, and stores the sampled data in a CSV-format database or the like. From the stored data, data necessary to display one-hour, one day, one-week, or one-month data is retrieved, and the data is averaged over the necessary period of time and presented for display in the form of a graph or the like.

FIG. 1 is a graph displayed according to the prior art by averaging the read response times of a certain system over every 10 minutes within a period of one day. In the illustrated example, six pieces of average value data from 1500 hours to 1600 hours are shown. Each of the six pieces of average value data shows the average value of the read response times measured at intervals of 30 seconds over a period of 10 minutes.

When it is desired to display the read response times for the previous day or the next day, the corresponding button on the screen must be clicked with a mouse.

In the prior art shown in FIG. 1, data necessary to display one-day, one-week, or one-month data is averaged over every predetermined period of time at predetermined intervals of time and presented for display; accordingly, the prior art has the problem that it takes a considerable time to grasp the high load time (peak time) of the system, because the data sampled at predetermined information sampling intervals has to be examined in sequence by the month, by the week, by the day, and by the hour.

The peak time here not only refers to the peak of the read response time, but also refers, for example, to the time at which the amount of data transfer or the number of R/W commands per unit time abruptly increases. Such abrupt increases can occur, for example, when the frequency of use of the system is high, or when a failure has occurred in the system.

FIG. 2 is a graph displayed according to the prior art by sampling read response times at intervals of five seconds over a period of one hour from 15:00 to 16:00 in a certain system. In the illustrated example, peak values occur at 15:08, 15:10, 15:21, 15:25, 15:26, 15:58, etc.

When it is desired to display the read response times for the previous hour or the next hour, the corresponding button on the screen should be clicked with a mouse.

In the prior art shown in FIG. 2, if it is desired to check the condition in the vicinity of, for example, 15:58, it is also necessary to bring the information for the next hour onto the screen and, hence, a problem that it takes time and trouble to display the performance information occurs.

### DISCLOSURE OF THE INVENTION

It is an object of the present invention to reduce the time and trouble required to display system performance information, by making provisions so that the performance information during a desired time period can be quickly displayed by a simple operation.

It is another object of the present invention to make it possible to switch from an average-value display to a peak display by a simple operation, thereby making it possible to grasp the operating performance of the system accurately.

To achieve the above objects, according to a first mode of the present invention, there is provided a performance information display program for displaying system performance information on a display apparatus, a storage medium for storing the program, and a method and apparatus for displaying the system performance information, wherein the program causes a computer to execute the steps of: periodically storing the system performance information in a storage device; reading the performance information out of the storage device; displaying the readout performance information based on a time axis; and changing, in accordance with a time period to be displayed as the time axis on the display apparatus, a time unit for determining values to be displayed based on the time axis.

In this way, a performance display with a desired time unit can be presented easily.

In the first mode, the displaying step may further comprise displaying average values taken at intervals of the unit time as the values to be displayed based on the time axis.

In this way, the average values of the performance information taken at intervals of the desired unit time can be easily presented for display.

In the first mode, the displaying step may further comprise displaying peak values taken at intervals of the unit time as the values to be displayed based on the time axis.

In this way, the peak values of the performance information taken at intervals of the desired unit time can be easily presented for display.

In the first mode, by clicking a button on a screen with a mouse, one of a plurality of time periods of different lengths can be selected as the time period to be displayed as the time axis.

In this way, the desired time unit can be selected by a simple operation.

The performance information is the amount of information transfer per unit time or the number of read/write commands per unit time.

### BRIEF DESCRIPTION OF THE DRAWINGS

These and other objects and features of the present invention will become clearer from the description of the best mode for carrying out the invention given below with reference to the accompanying drawings.

FIG. 1 is a graph displayed according to the prior art by averaging data over every 10 minutes during the operating hours of a certain system within a period of one day.

FIG. 2 is a graph displayed according to the prior art by sampling data at intervals of five seconds over a period of one hour from 15:00 to 16:00 during the operating hours of a certain system.

FIG. 3 is a block diagram showing a configuration example of a storage area network (SAN) management system which implements a performance display method according to one embodiment of the present invention.

FIG. 4 is a flowchart for explaining a portion of the performance display method according to the one embodiment of the present invention.

FIG. 5 is a flowchart for explaining the remaining portion of the performance display method according to the one embodiment of the present invention.

FIG. 6 is a diagram showing one example of a screen display for explaining the performance display method according to one embodiment of the present invention when a peak display is presented for viewing.

FIG. 7 is a diagram showing one example of a screen display in which a desired screen is displayed in the center of the screen display in accordance with the one embodiment of the present invention.

### BEST MODE FOR CARRYING OUT THE INVENTION

An embodiment of the present invention will be described below.

FIG. 3 is a block diagram showing a configuration example of a storage area network (SAN) management system which implements a performance display method according to one embodiment of the present invention. In the figure, reference numeral 31 is a first server, 32 is a display apparatus connected to the server 31, 33 is a computer connected to the server 31, 34 is a second server, 35 is a switch, and 36 is a RAID.

An application program for managing the switch 35 or the RAID 36 is stored on a hard disk or in some other storage device (not shown) within the computer 33, and the performance of the switch 35 or the RAID 36 is periodically read into the server 31 for storing therein at predetermined intervals of time in accordance with the embodiment of the present invention. The computer 33, the servers 31 and 34, the switch 35, and the RAID 36 are interconnected via a LAN. The server 34, the switch 35, and the RAID 36 are interconnected, for example, by an optical fiber.

Next, the operation will be described. First, the performance management function in the SAN management is enabled to initiate information acquisition from the system (the switch 35 or the RAID 36).

An application program stored in the server 31 collects data from the switch 35 or the RAID 36 periodically at predetermined information sampling intervals and stores the data in the server 31. It also accumulates data of average values taken over every ten minutes and every one hour in order to display one-day and one-week graphs. Further, calculations are performed to identify a high load condition, and if the data shows a higher load than the previous data, the current data is held, and the peak data are thus accumulated to provide a set of data for one day and one week. Based on this information, specified performance information is displayed in the form of a graph.

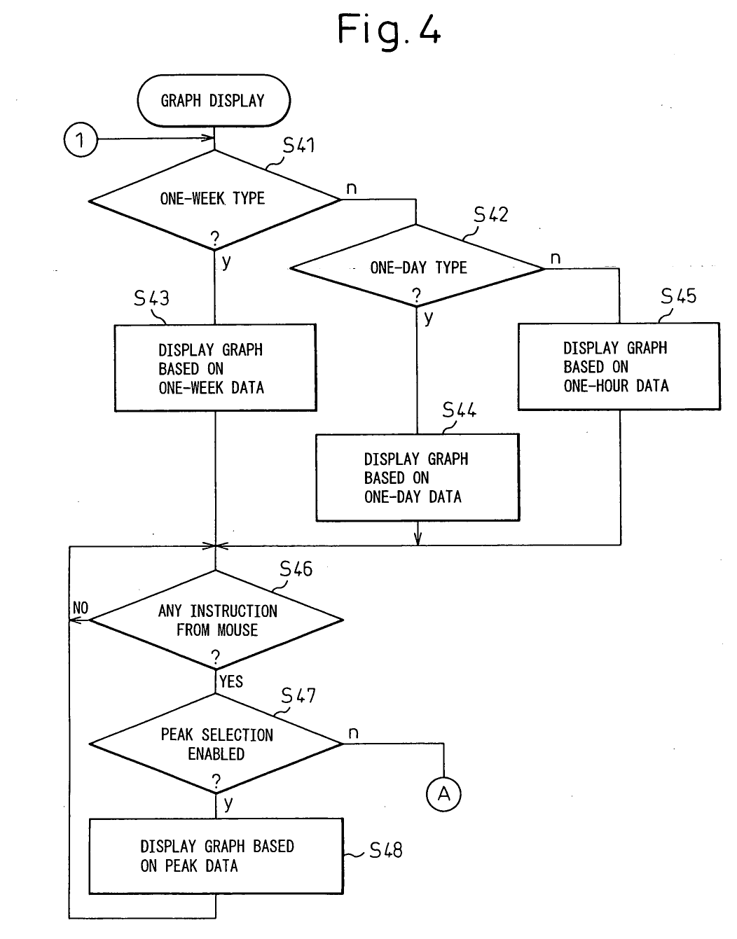

FIG. 4 is a flowchart for explaining a portion of the performance display method according to the one embodiment of the present invention.

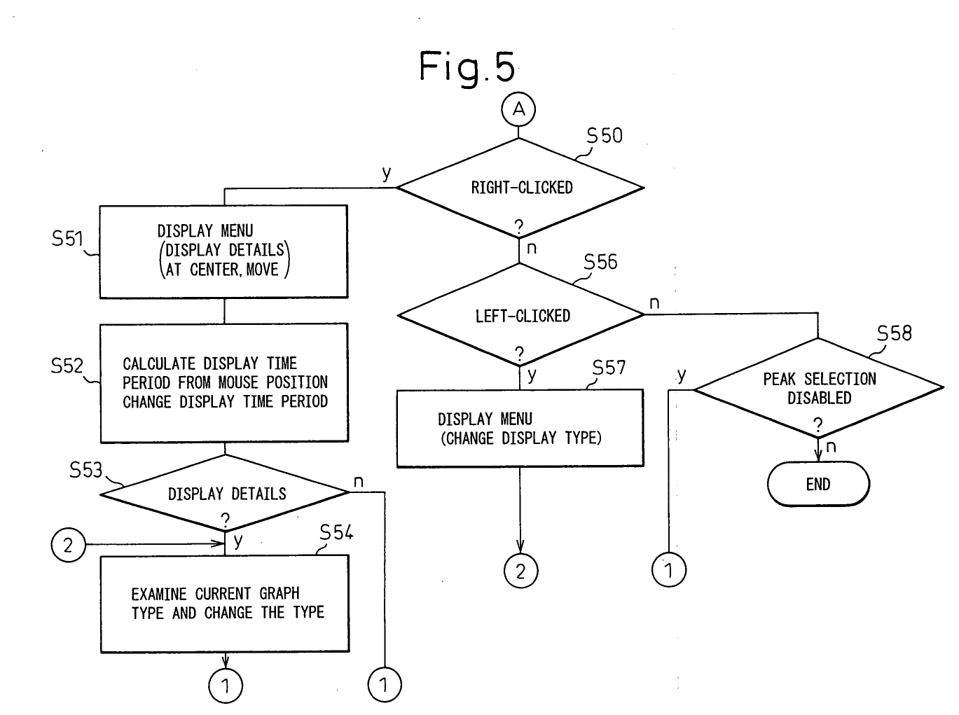

FIG. 5 is a flowchart for explaining the remaining portion of the performance display method according to the one embodiment of the present invention.

In FIG. 4, a selector button for making a selection between a one-day graph and a one-week graph is provided on the screen. In step S41, it is determined whether the selector button is set to select the one-week type; if the answer is NO, then it is determined in step S42 whether the selector button is set to select the one-day type.

On the other hand, if the answer to step S41 is YES, the process proceeds to step S43 where a graph of the performance is displayed based on one-week data by using the average values taken at predetermined intervals of time.

If the answer to step S42 is YES, the process proceeds to step S44 where a graph of the performance is displayed based on one-day data by using the average values taken at predetermined intervals of time, but if the answer is NO, the process proceeds to step S45 where a graph of the performance is displayed based on one-hour data by using the average values taken at predetermined intervals of time.

Next, in step S46, the process waits until an instruction is entered from a mouse. When an instruction is entered from the mouse, it is determined in step S47 whether peak selection is enabled or not. If it is enabled, the graph is displayed in step S48 based on the peak data. That is, the display is switched from the average-value display to the peak-data display.

If the answer to step S47 is NO, the process proceeds to step S50 in FIG. 5 to determine whether the cursor has been moved to a desired position on the displayed graph and the mouse has been right-clicked. If the answer is YES, then a menu “DISPLAY DETAILS AT CENTER, MOVE” is displayed in step S51.

Next, it is determined in step S52 whether the DISPLAY DETAILS button is selected on the screen. If it is selected, the current graph type is examined in step S54, and the type is changed to a further detailed type, after which the process returns to step S41 in FIG. 4.

The process also returns to step S41 in FIG. 4 when the DISPLAY DETAILS button is not selected in step S53.

If, in step S50, there is no right-click on the mouse, the process proceeds to step S56 to determine whether the mouse has been left-clicked; if YES, a menu “CHANGE DISPLAY TYPE” is displayed in step S57.

If it is determined in step S56 that there is no left-click either, the process proceeds to step S58 to determine whether peak selection is disabled or not. If it is disabled, the process is terminated, but if it is enabled, the process returns to step S41 in FIG. 4.

The above process can be summarized as follows.

When the PEAK button on the screen is selected, the graph of average values displayed on the screen of the display apparatus is quickly switched under the control of the computer 33 to the peak graph based on the peak data stored in the server 31, and the button on the screen now shows PEAK ON.

With the button on the screen showing PEAK ON, if the button is selected again, the displayed graph switches back to the graph of average values.

By thus switching the graph, it becomes possible to provide a rough guide in determining the high load (peak) time in a long-period graph display.

It also becomes possible to redisplay the graph centered around the position specified by the mouse on the displayed graph. By displaying the graph centered around the specified position, it becomes possible to grasp the operating condition before and after the specified time.

Furthermore, the currently displayed graph can be displayed in a further detailed form. That is, when the detailed display is selected, the currently displayed one-week graph can be switched to a one-day graph, and the currently displayed one-day graph can be switched to a one-hour graph. In this way, the high load time can be identified easily.

The following describes how the high load time is identified from a one-week graph by operating the graph display.

First, the one-week graph for the desired period is displayed (step S43).

On the screen where the graph is displayed, the PEAK button is enabled in order to display a peak graph (step S48).

The desired time is located from the peak graph.

The cursor is moved to a position near a peak time, and the mouse is right-clicked (step S50).

When the mouse is right-clicked, it becomes possible to select the detailed display by clicking the DISPLAY DETAILS button on the screen; therefore, the detailed display is selected (step S54).

The application then calculates the cursor position (time) from the one-day data, reads the data centered around that time, and displays the peak graph. The high load time is identified from the thus displayed graph.

Here, the cursor is moved to the position of the time where the data is to be displayed in further detail, and the mouse is right-clicked to specify the detailed display (step S50).

As in the case of the one-week graph display, the clicked position is calculated, thereby calculating the specified time, and when the detailed display is selected, the graph is displayed centered around the specified time. In this way, the operating condition centered around the high load time of the system can be displayed, making it possible to quickly and easily grasp the high load condition.

The performance information to be displayed includes, for example, the amount of information transfer per unit time and the number of read/write commands per unit time; in the case of the switch, the amount of receive/transmit data transfer and the number of CRC errors can be displayed, and in the case of the RAID, the number of reads and writes, the amount of data transfer, response times, read/prefetch/write hit rates, disk usage rates, and module usage rates can be displayed.

In accordance with the selected display time period, the program of the present invention automatically changes the unit time for the values to be plotted on the graph.

For example, it is assumed that 20 minutes, one hour, one day, and one week can each be specified as the display time period. In this case, when the 20-minute period is specified as the display time period, if the unit time is 10 seconds, then the number of pieces of data plotted is 120, and an easy-to-view graph display can be presented for the user to grasp the performance.

On the other hand, when the one-week period is specified, if the unit time is 10 seconds as in the above case, the number of pieces of data plotted will exceed 60,000, which is extremely inconvenient when it comes to observing statistical information.

Accordingly, regardless of the selected display time period, the number of pieces of data plotted is adjusted to about 100 in the present invention; for example, by automatically adjusting the unit time to 10 seconds in the case of the 20-minute display period, to 30 seconds in the case of the one-hour display period, to 12 minutes in the case of the one-day display period, and to 2 hours in the case of the one-week display period, easy-to-view information can be presented for the user.

Referring to FIG. 4, the adjustment of the unit time is performed in step S43, step S44, and step S45, respectively. According to the above example, in step S43 the unit time is set to 2 hours, and the performance graph is constructed by plotting the average performance or peak performance at intervals of 2 hours on the graph. In step S44, the unit time is set to 12 minutes, and the performance graph is constructed by plotting the average performance or peak performance at intervals of 12 minutes on the graph. In step S45, the unit time is set to 30 seconds, and the performance graph is constructed by plotting the average performance or peak performance at intervals of 30 seconds on the graph.

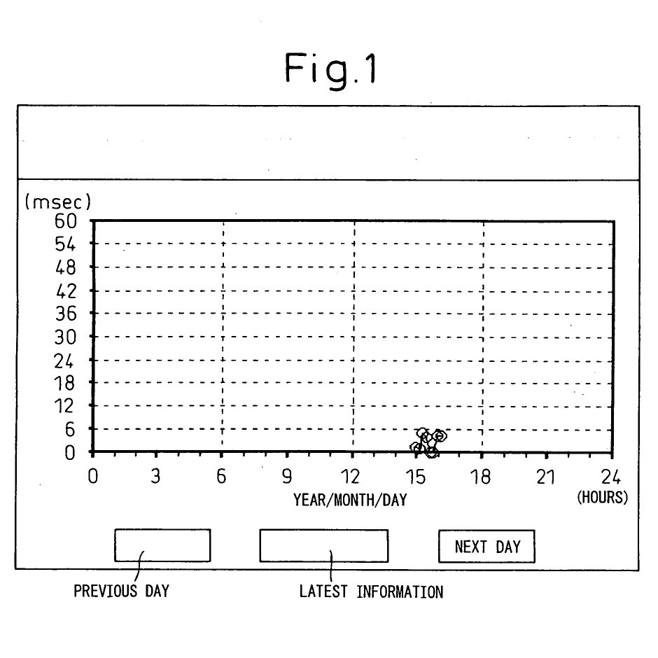

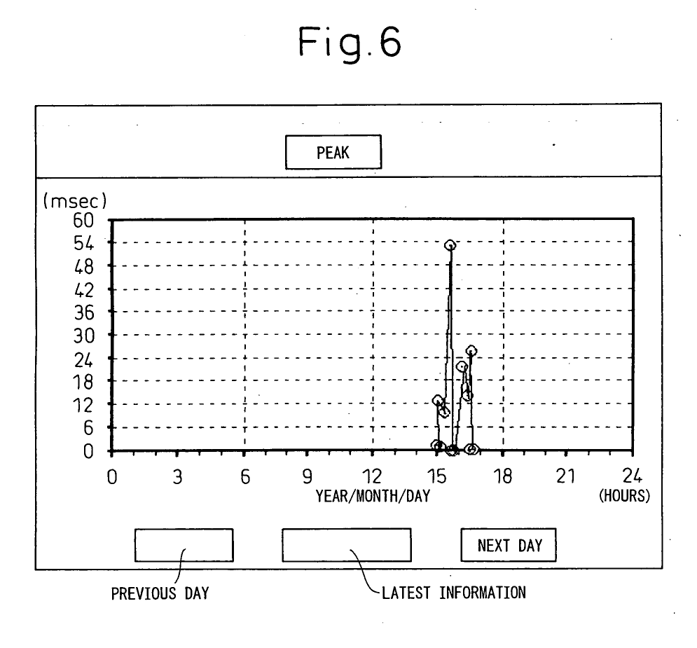

FIG. 6 is a diagram showing an example of a screen in which the PEAK button according to the embodiment of the present invention is included in the prior art graph display of FIG. 1; the screen shown here displays the graph produced by clicking the PEAK button with a mouse. In FIG. 6, measured values are directly displayed instead of peak values, and each measured point is plotted with an open circle. From the graph, it can be seen that the peak values are concentrated in the second half of the time segment between 1500 hours and 1600 hours.

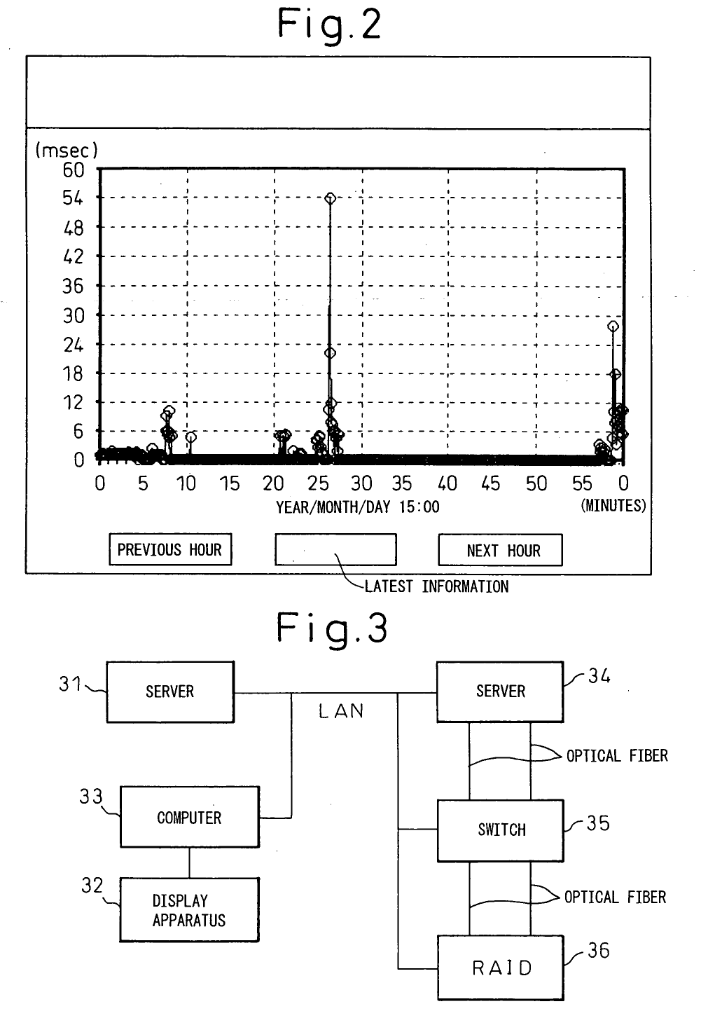

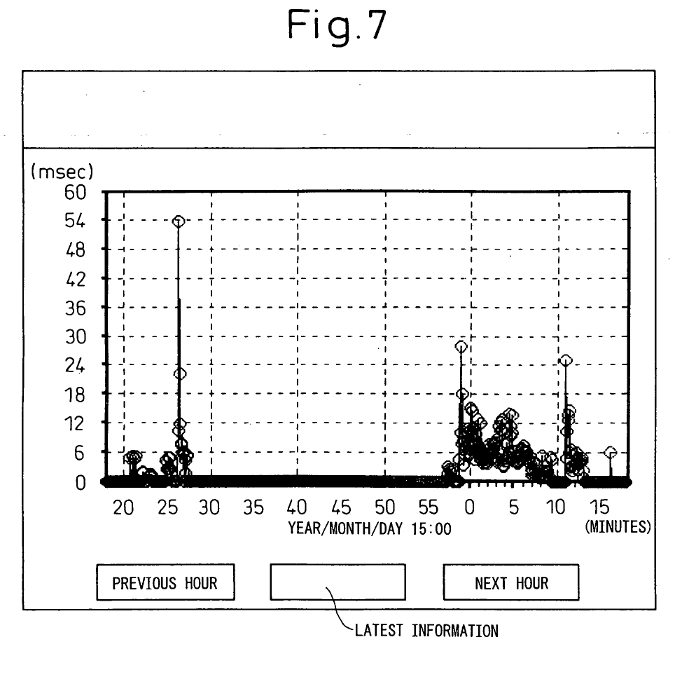

FIG. 7 is a diagram showing the screen produced when the cursor is moved to a position near 15:48 on the graph of FIG. 6 and the mouse is clicked on it to display a one-hour graph centered around that time. From the graph, it can be seen that a high load instantaneously appears at around 15:27 but the load is concentrated in the time segment between 15:58 and 16:13. To view the graph where the load is concentrated in the time segment running over the boundary between 1500 hours and 1600 hours, in the prior art the one-hour graph starting from 1500 hours and the one-hour graph starting from 1600 hours have had to be displayed by switching from one to the other, as shown in FIG. 2, but according to the present invention, by moving the desired time position to the center of the screen, the high load condition can be analyzed on the same screen.

While the above embodiment has been described by taking as an example the case where the screen display is switched between a one-week graph, a one-day graph, and a one-hour graph, the present invention is not limited to this particular example, but provisions may be made to switch between a plurality of time periods of different lengths as needed, for example, a one-month period, a one-year period, and so on. Further, the operation has been described as being performed by moving the cursor and clicking the mouse, but instead, the operation may be performed using a keyboard.

### INDUSTRIAL APPLICABILITY

As is apparent from the above description, according to the present invention, as the system performance during a desired time period can be quickly displayed on the screen by a simple operation, the trouble to bring the performance display onto the screen is alleviated and analysis time can be reduced.

Furthermore, as the system performance display can be switched from the average-value display to the peak display by a simple operation, it becomes possible to grasp the operating performance of the system accurately.

1. A performance information display program for displaying system performance information on a display apparatus, wherein said program causes a computer to execute the steps of:
periodically storing said system performance information in a storage device;
reading said performance information out of said storage device;
displaying said readout performance information based on a time axis; and
changing, in accordance with a time period to be displayed as said time axis on said display apparatus, a time unit for determining values to be displayed based on said time axis.

2. A performance information display program as claimed in claim 1, wherein said displaying step further comprises displaying average values taken at intervals of said unit time as said values to be displayed based on said time axis.

3. A performance information display program as claimed in claim 1, wherein said displaying step further comprises displaying peak values taken at intervals of said unit time as said values to be displayed based on said time axis.

4. A performance information display program as claimed in claim 1, further comprising the step of selecting one of a plurality of time periods of different lengths as the time period to be displayed as said time axis, by clicking a button on a screen with a mouse.

5. A performance information display program as claimed in claim 1, wherein said performance information represents the amount of information transfer per unit time.

6. A performance information display program as claimed in claim 1, wherein said performance information represents the number of read/write commands per unit time.

7. A performance information display apparatus for displaying system performance information on a display apparatus, comprising:
means periodically storing said system performance information in a storage device;
means reading said performance information out of said storage device;
means displaying said readout performance information based on a time axis; and
means changing, in accordance with a time period to be displayed as said time axis on said display apparatus, a time unit for determining values to be displayed based on said time axis.

8. A performance information display apparatus as claimed in claim 7, wherein said displaying means further comprises means displaying average values taken at intervals of said unit time as said values to be displayed based on said time axis.

9. A performance information display apparatus as claimed in claim 7, wherein said displaying means further comprises means displaying peak values taken at intervals of said unit time as said values to be displayed based on said time axis.

10. A performance information display apparatus as claimed in claim 7, further comprising means selecting one of a plurality of time periods of different lengths as the time period to be displayed as said time axis, by clicking a button on a screen with a mouse.

11. A performance information display apparatus as claimed in claim 7, wherein said performance information represents the amount of information transfer per unit time.

12. A performance information display apparatus as claimed in claim 7, wherein said performance information represents the number of read/write commands per unit time.

13. A performance information display program storage medium storing a program for displaying system performance information on a display apparatus, wherein said program causes a computer to execute the steps of:
periodically storing said system performance information in a storage device;
reading said performance information out of said storage device;
displaying said readout performance information based on a time axis; and
changing, in accordance with a time period to be displayed as said time axis on said display apparatus, a time unit for determining values to be displayed based on said time axis.

14. A performance information display method for displaying system performance information on a display apparatus, comprising:
periodically storing said system performance information in a storage device;
reading said performance information out of said storage device;
displaying said readout performance information based on a time axis; and
changing, in accordance with a time period to be displayed as said time axis on said display apparatus, a time unit for determining values to be displayed based on said time axis.
